(19) United States
(12) Patent Application Publication
(10) Pub. No.: US 2014/0166460 A1
(43) Pub. Date: Jun. 19, 2014

(54) KEY STRUCTURE

(71) Applicant: Ya-Chun Tu, Taipei City (TW)

(72) Inventor: Ya-Chun Tu, Taipei City (TW)

(73) Assignee: ASUSTEK COMPUTER INC., Taipei City (TW)

(21) Appl. No.: 13/913,496

(22) Filed: Jun. 9, 2013

(30) Foreign Application Priority Data
Dec. 19, 2012 (TW) 101148422

(51) Int. Cl. H01H 13/14

(52) U.S. Cl. CPC H01H 13/14
USPC 200/530

(57) ABSTRACT

A key structure comprises a bottom portion, a keycap and an elastic element. The bottom portion includes a pressing portion. The keycap includes a conducting portion and a fixing portion. The elastic element is a hollow structure formed by linear winding, and it is disposed between the bottom portion and the keycap. The conducting portion passes through the hollow structure and corresponds to the pressing portion, and the fixing portion is used to fix the elastic element. The keycap is movably fixed to the bottom portion, and the conducting portion is connected to the pressing portion when the keycap moves towards the bottom portion.

### CROSS-REFERENCE TO RELATED APPLICATION

This application claims the priority benefit of Taiwan application serial No. 101148422, filed on Dec. 19, 2012. The entirety of the above-mentioned patent application is hereby incorporated by reference herein and made a part of specification.

### BACKGROUND OF THE INVENTION

1. Field of the Invention

The invention relates to a key structure and, more particularly, to a key structure whose structure is different from the structure of conventional key structures.

2. Description of the Related Art

With the development of the technology, electronic products are widely used, and common electronic devices include smart phones, notebooks and tablet computers according to their main functions.

Taking a personal computer (PC) as an example, the PC usually includes a keyboard for inputting data in order to facilitate users storing data to the PC. The conventional key structure of the keyboard is composed of a keycap, rubber, a bottom potion and the interlock mechanism between the keycap and the bottom potion. The interlocking mechanism includes two crossing brackets pivotally connected, namely a scissor structure. When assembling the key structure of the keyboard, first, the rubber is attached to the bottom potion, subsequently, the brackets are crossed and pivotally connected to form the interlocking mechanism, and then the interlocking mechanism is connected between the keycap and the bottom potion. However, the method of assembling the key structure of the keyboard is inconvenient and difficult due to the multi-components.

### BRIEF SUMMARY OF THE INVENTION

A key structure is disclosed. The key structure comprises a bottom portion, a keycap and an elastic element. The bottom portion includes a pressing portion. The keycap includes a conducting portion and a fixing portion. The elastic element is a hollow structure formed by linear winding, and it is disposed between the bottom portion and the keycap. The conducting portion passes through the hollow structure and corresponds to the pressing portion, and the fixing portion is used to fix the elastic element. The keycap is movably fixed to the bottom portion, and the conducting portion is connected to the pressing portion when the keycap moves towards the bottom portion

Above all, the elastic element is disposed between the bottom portion and the keycap, and the elastic element is fixed by the fixing portion, and the assembly of the key structure is completed. Compared to the conventional key structure, it is easy to assemble and time-saving due to the simple structure of the key structure.

The features and advantages of the present invention will become better understood with regard to the following descriptions and accompanying drawings.

### BRIEF DESCRIPTION OF THE DRAWINGS

FIG. 1 is a schematic diagram showing a key structure in an embodiment.

FIG. 2A to FIG. 2C are flowcharts showing the manufacture of the key structure 100 shown in FIG. 1

FIG. 3 is a schematic diagram showing a key structure in another embodiment.

### DETAILED DESCRIPTION OF THE EMBODIMENTS

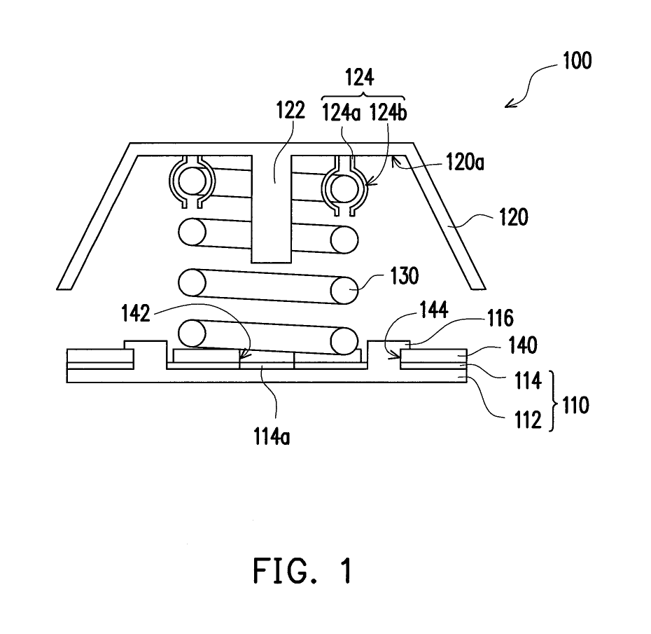

FIG. 1 is a schematic diagram showing a key structure in an embodiment. Please refer to FIG. 1, the key structure 100, such as a key on a membrane keyboard, includes a bottom portion 110, a keycap 120, an elastic element 130 and a fixing element 140, the bottom portion 110 includes a baseplate 112 and a film circuit board 114, the film circuit board 114 is disposed on the baseplate 112, and the film circuit board 114 includes a pressing portion 114a.

The keycap 120 includes a conducting portion 122 and two fixing portions 124, the fixing portions 124 are at the undersurface 120a of the keycap 120, and the conducting portion 122 is positioned between the two fixing portions 124. The conducting portion 122 may be a pillar which is used for contacting the film circuit board 114 of the bottom portion 110.

In the embodiment, the elastic element 130 may be a spring and it is positioned between the bottom portion 110 and the keycap 120 to movably fix the keycap 120 to the bottom portion 110. The fixing portion 124 may be a water-drop structure used for fixing one end of the elastic element 130 (the end close to the keycap 120). There are two fixing portions 124 in FIG. 1, which is not limited herein, the number and the position of the fixing portion may be adjustable according to the key structure. The fixing portion 124 includes a connecting element 124a and a though hole 124b. The connecting element 124a is connected to the undersurface 120a of the keycap 120, and the elastic element 130 is fixed to the elastic element 130 by passing through the though hole 124b to.

The fixing element 140 includes a passing hole 142. The fixing element 140 and the bottom portion 110 are assembled together, and the elastic element 130 is fixed at the bottom portion 110. The elastic element 130 and the fixing element 140 may be integrally formed, which may be formed by injection molding. As a result, the elastic element 130 can be assembled and fixed at the bottom portion 110 via the fixing element 140.

The fixing element 140 may include one or a plurality of assembling holes 144, and there are two assembling holes in the figure as example. The baseplate 112 includes one or a plurality of hooks 116, there are two assembling holes in the figure as example, which is not limited herein. The hook 116 passes through the assembling hole 144 to assemble the fixing element 140 and the bottom portion 110 together, and the fixing method is not limited herein. For example, a hook may be disposed on the fixing element, and the corresponding assembling hole is disposed on the baseplate to assemble the fixing element 140 and the bottom portion 110 together.

The conducting portion 122 is disposed at the undersurface 120a of the keycap 120 and corresponds to the pressing portion 114a. The keycap 120 moves towards the bottom portion 110 when the keycap 120 is pressed, and the elastic element 130 deforms to make the conducting portion 122 pass through the passing hole 142 and contact the pressing portion 114a of the film circuit board 114, so that to trigger the key structure 100, and thus an input instruction can be transmitted to the electronic device (such as a notebook computer) via the film circuit board 114.

The elastic element 130 may be a spring or any other hollow structure formed by winding linear elements, and the hollow structure may be cylindrical or square shaped, which is not limited herein. When the external force of pressing the keycap 120 disappears, the elastic element 130 makes keycap 120 quickly restore to the original position before it is pressed by its own elasticity, so that users can continue to input data.

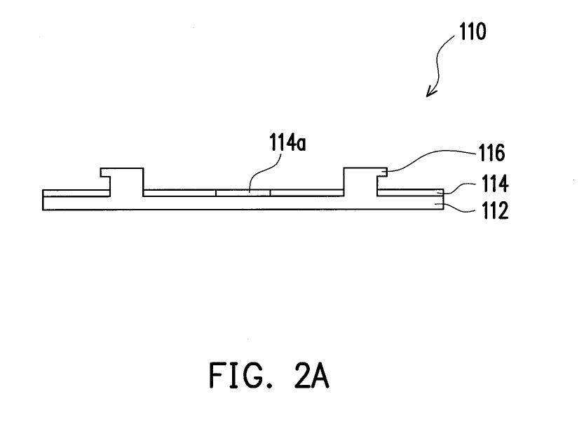

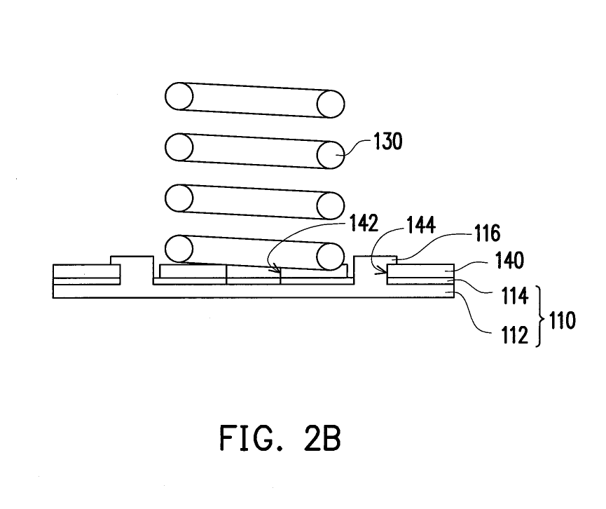

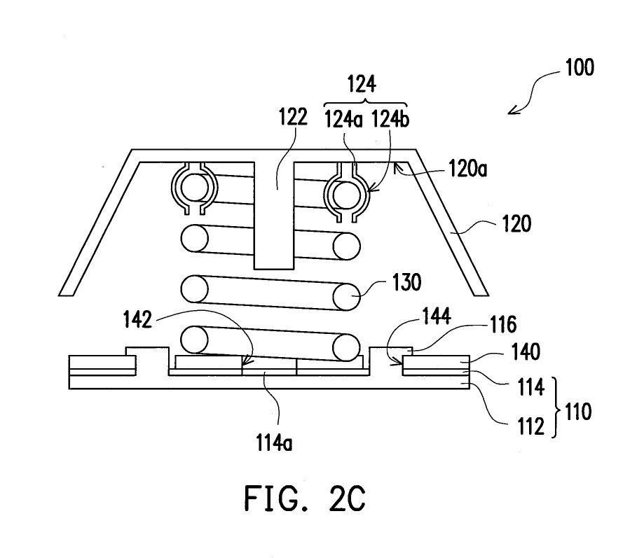

Under this configuration, the elastic element 130 is disposed between the bottom portion 110 and the keycap 120, and the elastic element 130 is fixed by the fixing portion 124, and the assembly of the key structure 100 is completed. Compared to the conventional key structure, it is easy to assemble and time-saving due to the simple structure of the key structure 100. The manufacture and assembly process of the key structure 100 will be illustrated in detail hereinafter. FIG. 2A to FIG. 2C are flowcharts showing the manufacture of the key structure 100 in FIG. 1.

Please refer to FIG. 2A, firstly, providing a bottom portion 110, the bottom portion 110 includes a baseplate 112 and a film circuit board 114. The film circuit board 114 is disposed on the baseplate 112 to form the bottom portion 110, and the film circuit board 114 includes a pressing portion 114a.

Then, refer to FIG. 2B, providing an elastic element 130 and a fixing element 140, and the elastic element 130 and the fixing element 140 are assembled to the bottom portion 110. In detail, the fixing element 140 includes an assembling hole 144, and the baseplate 112 includes a hook 116. The hook 116 passes through the assembling hole 144 to assemble the fixing element 140 and the bottom portion 110 together. The elastic element 130 may be a spring, and the elastic element 130 is combined with the fixing element 140 by the injection molding. For example, the elastic element 130 is placed in a preset mold, and then the elastic member 130 is combined with the fixing element via the injection molding.

Finally, the keycap 120 and the elastic element 130 are assembled together, and the assembly process of the key structure 100 is completed as shown in FIG. 2C. The keycap 120 includes a conducting portion 122 and a fixing portion 124. The fixing portion 124 is at the undersurface 120a of the keycap 120. The fixing portion 124 may be a water-drop structure used for fixing one end (the end close to the keycap 120) of the elastic element 130. In detail, the elastic element 130 passes through the though hole 124b of the fixing portion 124 to fix the elastic element 130.

In addition, the keycap 120 may be integrally molded (such as formed by plastic injection molding) or molded by combination. In other words, the material of the keycap 120 and the conducting portion 122 may be a plastic material, so the conductive portion 122 can be made by a plastic molding manner. On the other hand, the conductive portion 122 may be made of rubber, silicone and other non-plastic materials. Therefore, the conducting portion 122 can be placed in a mold after it is completed, and then the keycap 120 is formed by injection molding.

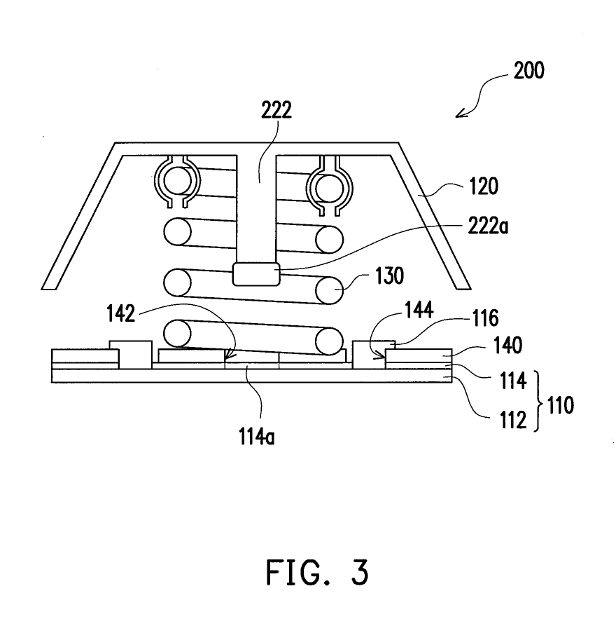

FIG. 3 is a schematic diagram showing a key structure in another embodiment. Please refer to FIG. 3, the difference between the key structure in FIG. 3 and that in FIG. 1 is the conducting portion 222 in FIG. 3 further includes a cushion 222a. The cushion 222a contacts the pressing portion 114a of the film circuit board 114 when the keycap moves towards the bottom portion 110.

In summary, the elastic element is disposed between the bottom portion and the keycap, and the elastic element is fixed by the fixing portion. Then, the assembly of the key structure 100 is completed. Compared to the conventional key structure, it is easy to assemble and time-saving due to the simple structure.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A key structure, comprising:
a bottom portion including a pressing portion;
a keycap including a conducting portion and a fixing portion; and
an elastic element which is a hollow structure formed by linear winding and disposed between the bottom portion and the keycap, wherein the conducting portion passes through the hollow structure and corresponds to the pressing portion, and the fixing portion is used to fix the elastic element;
wherein the keycap is movably fixed to the bottom portion, and the conducting portion is connected to the pressing portion when the keycap moves towards the bottom portion.

2. The key structure according to claim 1, wherein the key structure further comprises a fixing element disposed at the bottom portion, and the fixing element fixes the elastic element at the bottom portion.

3. The key structure according to claim 2, wherein the fixing element and the elastic element are integrated formed.

4. The key structure according to claim 2, wherein the fixing element includes a passing hole, and the conducting portion passes through the passing hole to contact the bottom portion when the keycap moves towards the bottom portion.

5. The key structure according to claim 2, wherein the fixing element includes an assembling hole, the bottom portion includes a baseplate and a film circuit board, the film circuit board is disposed on the baseplate and includes a hook, and the hook passes through the assembling hole to assemble the fixing element with the bottom portion.

6. The key structure according to claim 1, wherein the fixing portion includes a though hole, and the elastic element passes through the though hole to fix the elastic element.

7. The key structure according to claim 1, wherein the fixing portion is at the undersurface of the keycap.

8. The key structure according to claim 1, wherein the conducting portion includes a cushion, the cushion contacts the bottom portion when the keycap moves towards the bottom portion.

9. The key structure according to claim 1, wherein the conducting portion and the keycap are integrated formed.

10. The key structure according to claim 1, wherein the elastic element is a spring.
